(19) United States
(12) Patent Application Publication
(10) Pub. No.: US 2017/0115486 A1
(43) Pub. Date: Apr. 27, 2017

(54) CONTROL OF GRAZING ANGLE STRAY LIGHT

(71) Applicant: Osterhout Group, Inc., San Francisco, CA (US)

(72) Inventors: John N. Border, Eaton, NH (US); Eric R. Drues, Richmond, CA (US)

(21) Appl. No.: 14/919,981

(22) Filed: Oct. 22, 2015

(51) Int. Cl. G02B 27/01; G02B 17/00; G02B 27/28; G02B 1/118

(52) U.S. Cl. CPC G02B 27/0172; G02B 1/118; G02B 17/008; G02B 27/286; G02B 2027/0118; G02B 2027/0145

(57) ABSTRACT

Compact optical assemblies for the display of an image in a head worn display with improved contrast include an image source that provides image light, a folded optic, wherein the image light passes adjacent to an optical surface of the folded optic so that stray light associated with the image light is incident onto the optical surface at a grazing angle, and a structure associated with the optical surface that prevents the stray light from reflecting off of the optical surface.

### BACKGROUND

### Field

This disclosure relates to optical configurations for compact, see-through computer display systems.

### SUMMARY

The disclosure provides methods and apparatus for controlling stray light associated with grazing angle reflections in the optical systems of a compact head mounted display.

In embodiments, an antireflective nanostructure is provided that has antireflection properties for light that is incident at a grazing angle. Where the nanostructure can be a moth-eye pattern that is embossed onto a film or molded onto a surface.

In further embodiments, a louvered set of blocking strips is provided where the blocking strips are oriented to allow image light to be transmitted while stray light that is incident onto the surface at a grazing angle is blocked. The blocking strips can be black to absorb the stray light. Alternatively if the stray light is polarized, the blocking strips can polarizers.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts an illustration of a compact optical assembly with a multiply folded optical path.

FIG. 2 depicts an illustration of a compact optical assembly with a multiply folded optical path that is folded to the back in the upper optics.

FIG. 2a depicts an illustration of a compact optical assembly with a folded optical path.

FIG. 3 depicts an illustration of a compact optical assembly with a multiply folded optical path that is folded to the side.

FIG. 4 depicts an illustration of a compact optical assembly with multiply folded optics that includes a laminated analyzer polarizer.

FIG. 5 depicts a modified analyzer polarizer that includes one or more thin blocking strips.

FIG. 6 depicts a frame that can be used to position thin blocking strips.

### DETAILED DESCRIPTION

In optical systems for compact head mounted displays it is often necessary to fold the optical path to reduce the overall size of the optics. This often results in a situation wherein light passes adjacent to an optical surface. Stray light associated with for example the illumination light or the image light, that has a slightly different angle than the illumination light or the image light can then be incident onto the adjacent optical surface at a grazing angle. Given that most optical surfaces have high reflectivity at grazing angles, the stray light is then reflected back into the optical system where it degrades the displayed image or adds a ghost image adjacent to the displayed image, both of which detract from the viewing experience. Even broadband multilayer antireflection coatings are not effective at reducing reflections when the light is at a grazing angle.

Consequently, methods and apparatus are needed to control stray light associated with grazing angle reflections of light in the optical systems of a compact head mounted display.

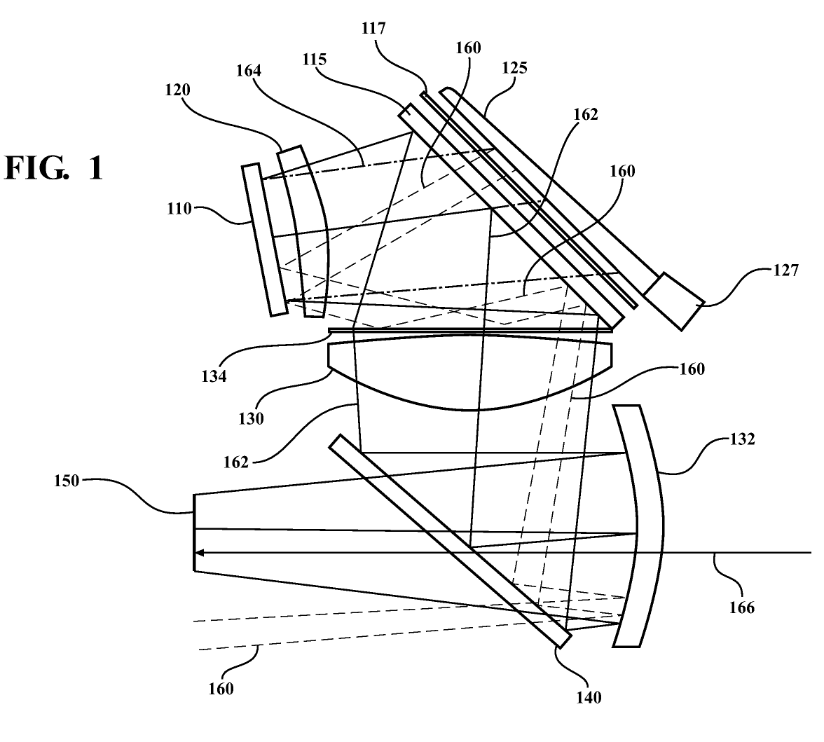

Compact optical systems for head mounted displays (HMDs) often utilize folded optical paths to reduce the overall size of the optical system. FIG. 1 shows an illustration of a compact optical assembly with a multiply folded optical path wherein image light passes adjacent to an optical surface so that grazing angle reflections of stray light are possible. The optical assembly shown in FIG. 1 includes upper optics and lower optics, wherein the upper optics include an image source 110, one or more lenses 120 and 130, and a fold mirror 115, and the optical path is folded to the back of the optical assembly. The lower optics include an angled beam splitter 140 and a curved partial mirror 132. The optical assembly provides a displayed image overlaid onto a see-through view of the surrounding environment that can be viewed by a user at the eyebox 150, wherein the displayed image comprises image light 162 and the see-through view of the surrounding environment comprises scene light 166. The image light 162 passes from the image source 110 and through the lens 120, wherein a portion is redirected by reflection from the fold mirror 115 and passes through lens 130, and a portion is redirected by reflection from the angled beam splitter 140 so that it proceeds toward the curved partial mirror 132. The curved partial mirror 132 reflects a portion of the image light 162 back toward the angled beam splitter 140 where a portion of the image light 162 passes through the angled beam splitter 140 on its way to the eyebox 150. At the same time, a portion of scene light 166 from the surrounding environment passes through both the curved partial mirror 132 and the angled beam splitter 140 on its way to the eyebox 150. The user then views a combined image comprising the displayed image overlaid onto the see-through view of the surrounding environment by placing their eye adjacent to the eyebox 150.

The image source 110 may be a reflective display such as a liquid crystal on silicon (LCOS) display, a ferroelectric liquid crystal on silicon (FLCOS) or a digital light projector (DLP) display, or an emissive display such as an organic light emitting diode (OLED), a micro-light emitting diode (micro-LED), a backlit liquid crystal, a rasterized laser onto a diffuser or a plasma display. While emissive displays include pixels that emit image light 162, reflective displays require illumination light 164 to be supplied by an area light source that can include a backlight 125 that distributes light from a light emitting diode (LED) 127 or other linear light source or point light source. In the case of an LCOS or FLCOS, the illumination light 164 can be polarized by including a polarizer 117 or by using a fold mirror 115 that includes a reflective polarizer such as a PBS wire grid polarizer, such as those supplied by Moxtek (Orem, Utah), or a multilayer film polarizer such as a DBEF film supplied by 3M (Minneapolis, Minn.). An analyzer polarizer 134 can then be included to increase contrast in the displayed image by absorbing off-state polarized light from the image source 110 and also to trap stray illumination light 164 that goes directly from the backlight 125 to the lens 130 and the lower optics. It should be noted that while illumination light 164 and image light 162 are shown as having narrow cone angles, they can actually have a more Lambertian distribution of light with a wide cone angle of light at a lower intensity. This wider cone angle of light can contribute substantial stray light that decreases the contrast in the displayed image and makes the black portions of the displayed image appear to be gray.

The lower optics can be polarized or non-polarized, wherein the angled beam splitter 140 or the curved partial mirror 132 can have reflection and transmission properties that are sensitive or insensitive to the polarization state of the image light 162 and the scene light 166. For the case where the lower optics are polarized, the angled beam splitter or the curved partial mirror have a higher reflectivity for one polarization state of the image light 162 or the scene light 166 while having a higher transmitivity for the other polarization state. Examples of surfaces that can be used on the angled beam splitter 140 and the curved partial mirror 132 that have reflection and transmission properties that are sensitive to polarization state include: wire grid polarizers, multilayer film polarizers and MacNeil polarizing beam splitters. Polarized lower optics may provide improved efficiency in delivering image light 162 to the eyebox 150. However, since surfaces that are sensitive to polarization state typically only transmit one polarization state, the transmission is limited to less than 50% of unpolarized light so that the efficiency of delivering scene light 166 to the eyebox 150 is limited to less than 50% and due to the interactions of multiple surfaces in the lower optics, the transmission may be less than 20%.

For the case where the lower optics are non-polarized, the angled beam splitter 140 and the curved partial mirror 132 reflect both polarization states of the image light 162 and the scene light 166 substantially equally. Examples of surfaces that can be used on the angled beam splitter 140 and the curved partial mirror 132 that are substantially insensitive to polarization state include: a partial mirror coating that reflects a % of incident light over an entire wavelength band (e.g. the visible wavelength band from 400-700 nm), a polka-dot beam splitter coating that acts as a mirror coating over a series of small spots on the surface where the relative area of the spots determines the % of incident light that is reflected, and a notch mirror coating that acts as a partial mirror coating over one or more narrow wavelength bands (e.g. a tristimulus notch mirror coating that reflects over three narrow wave length bands such as 440-460 nm, 520-550 nm and 640-660 nm). Because the reflectivity of surfaces that are insensitive to polarization state of incident light can be designed to provide various levels of reflection, non-polarized lower optics can be provided with high transmission (e.g. greater than 50%) of scene light 166 to the eyebox 150 while providing an acceptable efficiency (e.g. greater than 5%) in delivering image light 162 to the eyebox 150.

There is another contribution to stray light that is the subject of the systems and methods according to the principles of the present disclosure. Stray light 160 that proceeds from the image source 110 at an angle such that it is incident onto the analyzer polarizer 134 at a grazing angle (i.e. an incident angle of greater than 70 degrees compared to the surface normal) is reflected by the analyzer polarizer 134 even if the surface is coated with a broadband multilayer dielectric antireflection coating to improve the transmission of the image light 162, because broadband multilayer dielectric antireflection coatings are typically not effective at grazing angles. In fact, nearly all optical surfaces are highly reflective for grazing angle incident light. This stray light 160 can come directly from the image source 110 if the image source 110 is an emissive display, or the stray light 160 can come from the backlight 125 if the image source 110 is a reflective display. In either case, the stray light 160 is incident on the analyzer polarizer 134 at a grazing angle. After being reflected by the analyzer polarizer, a portion of the stray light 160 is reflected by the fold mirror 115 so that it is directed toward the lower optics. In the lower optics, portions of the stray light 160 are reflected by the angled beam splitter 140 and the curved partial mirror 132 as shown in FIG. 1 so that the stray light 160 is presented adjacent to and below the eyebox 150. Because users tend to move their eyes around the eyebox 150 to look at different portions of the image or to look at different portions of the see-through view of the surrounding environment, the stray light 160 can be visible adjacent to the displayed image. Because the stray light 160 comes from the image source 110, there is image content associated with the stray light 160. In addition, because the stray light 160 is exposed to one more reflections (as shown in FIG. 1) than the image light 162, the image content associated with the stray light 160 is reversed relative to the displayed image. As such, the stray light 160 is seen by the user as a partial image adjacent to the displayed image and with reversed image content.

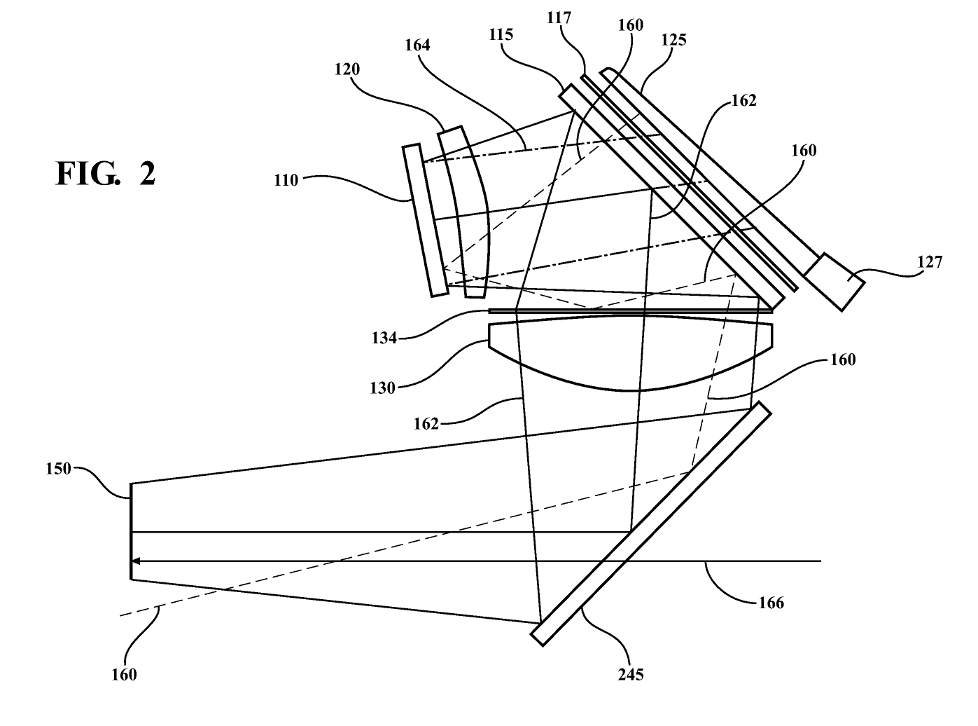

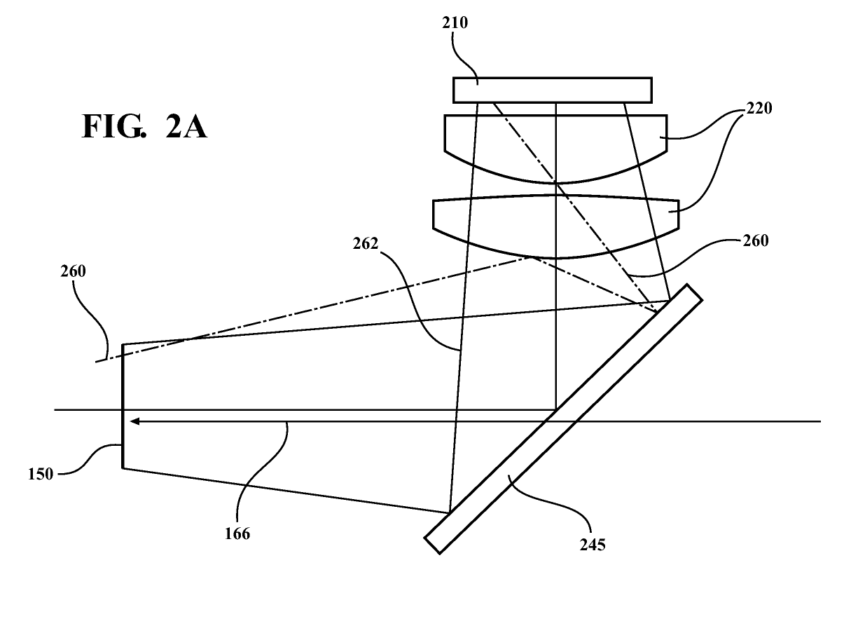

FIG. 2 is an illustration of another compact optical assembly with a multiply folded optical path wherein image light passes adjacent to an optical surface so that grazing angle reflections of stray light are possible. As with the compact optical assembly shown in FIG. 1, the compact optical assembly shown in FIG. 2 has a multiply folded optical path that is folded to the back in the upper optics. The compact optical assembly of FIG. 2 includes lower optics with a planar beam splitter 245 that directs the image light 162 directly to the eyebox 150. The planar beam splitter 245 can include a reflective polarizer or a non-polarized partially reflective coating or film. The planar beam splitter 245 also transmits scene light 166 so that the user sees a displayed image comprising image light 162 overlaid onto a see-through view of the surrounding environment comprising scene light 166. As with the optics shown in FIG. 1, the optics shown in FIG. 2 also have issues associated with stray light 160 that is reflected by the analyzer polarizer 134 because the stray light 160 is incident to the analyzer polarizer 134 at a grazing angle. Again, the stray light 160 is reflected by the planar beam splitter 245 so that it is presented adjacent to the eyebox 150 where it can be seen when the user moves their eye to the edge of the eyebox 150.

FIG. 2a is an illustration of a further compact optical assembly with a folded optical path wherein image light passes adjacent to an optical surface so that grazing angle reflections of stray light are possible. The compact optical assembly shown in FIG. 2 includes an emissive image source 210 such as, for example, an OLED or a backlit LCD and has a folded optical path that includes lower optics with a partially reflective planar beam splitter 245 that directs the image light 262 directly to the eyebox 150. The planar beam splitter 245 also transmits scene light 166 so that the user sees a displayed image comprising image light 162 overlaid onto a see-through view of the surrounding environment comprising scene light 166. The optics shown in FIG. 2 illustrate how stray light 260 coming from an oblique angle from the image source 210 can be reflected by the planar beam splitter 245 so that the stray light 260 is incident at a grazing angle onto a surface of one of the lenses 220. The stray light 260 is reflected by the surface of the lens 220 so that it is presented adjacent to the eyebox 150 where it can be seen either above the displayed image or when the user moves their eye to the upper edge of the eyebox 150. While stray light 260 that reflects from the surface of a lens 220 is only shown in the optical assembly of FIG. 2a, stray light of this type is also possible with the optical assemblies shown in FIGS. 1, 2 and 3.

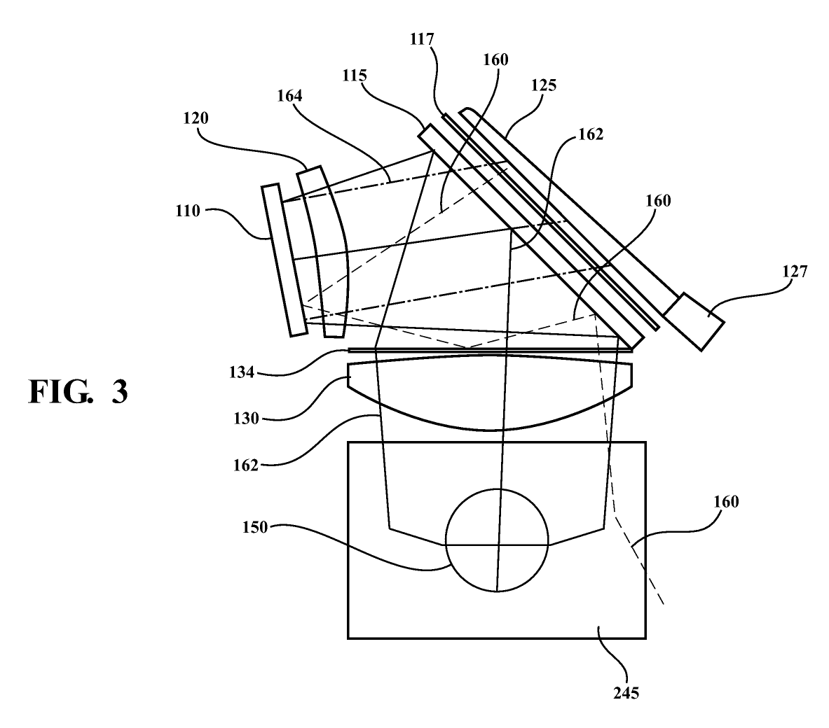

FIG. 3 is an illustration of yet another compact optical assembly similar to that shown in FIG. 2, but with a multiply folded optical path that is folded to the side in the upper optics, where FIG. 3 shows the optics as viewed from the back, looking straight into the eyebox 150. In this case, the stray light 160 is presented adjacent to and to the side of the eyebox 150, so that a partial image can be visible adjacent to and to the side of the displayed image.

These multiple examples of compact optics that suffer from stray light (shown in FIGS. 1-3) caused by grazing angle reflections of light from an optical surface show that this issue is common to a variety of different types of optical designs when there is a folded optical path that places image light 162 adjacent to an optical surface. In all the cases, a broad cone angle of light, in the cases shown it is image light but it could be illumination light as well, causes light to go where it is not intended to go and as a result, reflection at grazing angles from adjacent optical surfaces is possible. While this issue could be solved, such as by eliminating folds in the optical path so that light doesn't pass adjacent to an optical surface where grazing angle reflections are possible, unfolding the optics greatly extends the overall height of the optical assembly, thereby making the optics not suited for use in an HMD. Consequently, to provide a good viewing experience for the user of the compact HMD, it is important to provide methods and apparatus that reduce stray light 160.

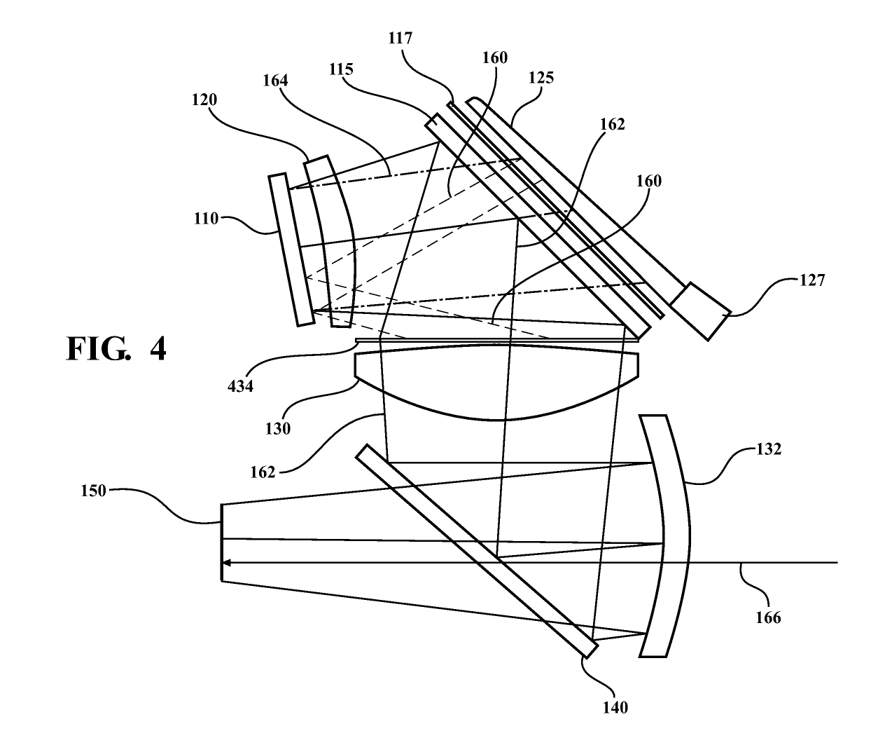

FIG. 4 is an illustration of a compact optical assembly with multiply folded optics for an HMD that includes a laminated analyzer polarizer 434, wherein the laminated analyzer polarizer 434 includes an upper layer with a nanostructure designed as an antireflective layer capable of operating over a broad range of incidence angles including grazing angle incidence. Moth-eye nanostructures provide antireflection properties over a wide range of incident angles, reflection of 5% at 75 degree incidence has been measured for hybrid moth-eye structures (see the published article by E. Perl, C. Lin, W. McMahon, D. Friedman, J. Bowers, “Ultrbroadband and Wide-Angle Hybrid Antireflection Coatings with Nanostructures”, IEEE Journal of Photovoltaics, Vol 4, No 3, May 2014, p 962-967). The upper layer with the nanostructure can be an additional layer that is bonded to the analyzer polarizer with at least one of an optically clear adhesive and a liquid adhesive. Alternatively, the nanostructure may be embossed onto a thermoplastic layer of the analyzer polarizer or embossed onto the analyzer polarizer using a master nanostructure surface and a UV cured material. The nanostructure can also be molded onto the surface of a lens (not shown) such as the lower surface of lens 220 to reduce the reflection of stray light 260 such as is shown in FIG. 2a.

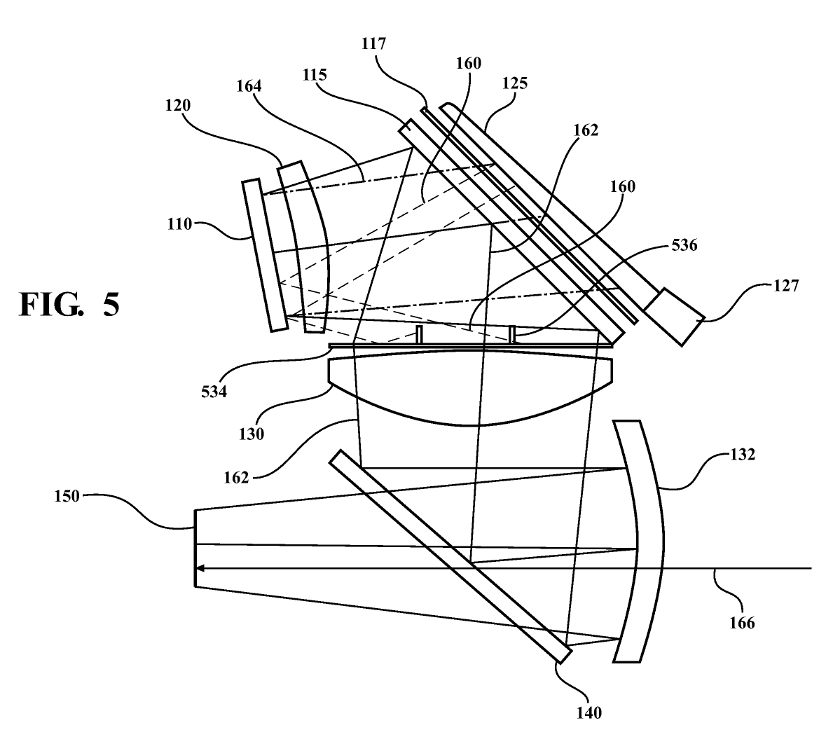

FIG. 5 shows a modified analyzer polarizer 534 that includes one or more thin blocking strips 536, where the thin blocking strips 536 are positioned with their thin dimension exposed to the image light 162 to reduce the interference with the image light 162. As a result, the wide dimension of the thin blocking strips 536 is exposed to the stray light 160 to effectively block the stray light 160. The thin blocking strips 536 may be a black absorbing material or a thin substrate material that is coated with a black absorbing material such as a flat black paint. Alternatively, if the image light 162 comprises polarized light, the thin blocking strips 536 can be strips of polarizer material. The thin blocking strips 526 can also be antireflection-coated to reduce reflections of the stray light 160 and to reduce scattering of the image light 162. While the thin blocking strips 526 are shown positioned above the lens 130 and associated with the analyzer polarizer 534, the thin blocking strips 526 can also be positioned below the lens 130 to block stray light 260 such as is shown in FIG. 2a.

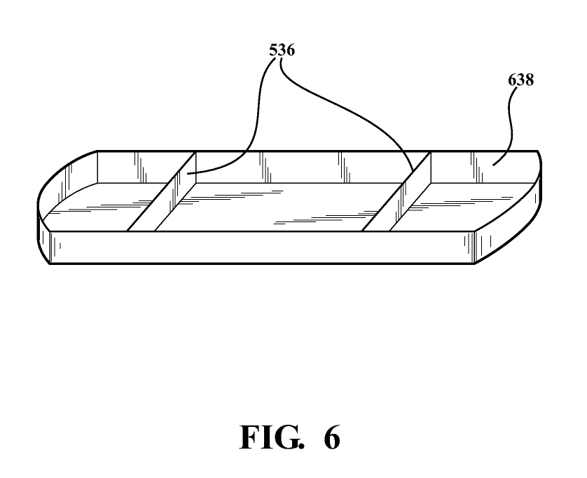

FIG. 6 shows a frame 638 that can be used to position the thin blocking strips 536. Two thin blocking strips 536 are shown in the frame, but more are possible. The frame 638 can be made with slots for the thin blocking strips 536 to be positioned in and thereby improve the accuracy of the positioning, where the thin blocking strips 536 are preferably held such that the wide dimension is parallel to the rays of image light 162 so that the blocking of the image light is reduced. The thin blocking strips may be adhesively bonded into the frame 638. In this way, the frame 638 with thin blocking strips 536 may be assembled and then positioned into the optics assembly as shown in FIG. 5 to block stray light 160 or positioned below the lens 220 to block stray light 260.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A compact optical assembly for the display of an image in a head worn display with improved contrast, comprising:
an image source that provides image light;
a folded optic, wherein the image light passes adjacent to an optical surface of the folded optic so that stray light associated with the image light is incident onto the optical surface at a grazing angle; and
a structure associated with the optical surface that prevents the stray light from reflecting off of the optical surface.

2. The compact optical assembly of claim 1, wherein the grazing angle includes angles of incidence greater than 70 degrees to the optical surface.

3. The compact optical assembly of claim 1, wherein the structure is a nano-structure that absorbs the grazing angle stray light.

4. The compact optical assembly of claim 3, wherein the nanostructure is a moth-eye structure.

5. The compact optical assembly of claim 4, wherein the moth-eye structure is at least one of a film and an embossed texture.

6. The compact optical assembly of claim 5, wherein the moth-eye structure is attached to the optical surface.

7. The compact optical assembly of claim 1, wherein the structure comprises one or more thin strips that extend across a portion of the optical surface so that they block the grazing angle stray light.

8. The compact optical assembly of claim 7, wherein the one or more thin strips comprise black film that absorbs a portion of the stray light.

9. The compact optical assembly of claim 7, wherein the image light is polarized and the thin strips comprise polarizer film.

10. The compact optical assembly of claim 7, wherein after passing adjacent to the optical surface, the image light is redirected by the folded optic to pass through the optical surface, and the thin strips are oriented to allow the image light to pass through the optical surface.

11. The compact optics assembly of claim 7, further comprising a frame to hold the thin strips in a position.

12. The compact optics assembly of claim 11, wherein the thin strips are bonded into the frame before the frame is positioned into the compact optics assembly.

13. The compact optics assembly of claim 7, wherein the thin strips are antireflection-coated.
